(19) United States
(12) Patent Application Publication
(10) Pub. No.: US 2020/0041291 A1
(43) Pub. Date: Feb. 6, 2020

(54) MULTI-MODAL METHOD OF TRANSPORTATION ROUTING

(71) Applicant: GOOGLE LLC, Mountain View, CA (US)

(72) Inventor: Robert Dunnette, New York, NY (US)

(21) Appl. No.: 16/484,436

(22) PCT Filed: Aug. 3, 2018
(86) PCT No.: PCT/US18/45168

§ 371 Date: Aug. 7, 2019

(51) Int. Cl. G01C 21/34; G06Q 30/02

(52) U.S. Cl. CPC G01C 21/3423; G01C 21/3667; G06Q 30/0283; G01C 21/3438

(57) ABSTRACT

An indication of a first starting location and a first destination is received from a first user device operated by a first user, and an indication of a second starting location and a second destination is received from a second user device operated by a second user. A multi-modal route from the first starting location to the first destination is generated in view of the second user travelling from the second starting location to the second destination. Generating the multi-modal route includes generating (i) a ride share segment of the multi-modal route which the first user and the second user can traverse together using a ride share service and (ii) a segment of the route associated with a mode of transport other than the ride share service. An indication of the multi-modal route from the first starting location to the first destination is provided to the first user device.

### FIELD OF THE DISCLOSURE

The present disclosure relates to geographic applications and, in particular, to providing step-by-step navigation directions using both public and private modes of transport.

### BACKGROUND

Today, digital maps of geographic areas and step-by-step directions for navigating through geographic areas can be provided on numerous electronic devices such as personal computers, tablets, mobile phones, navigators provided as special-purpose device or embedded into head units of vehicles, etc. The digital maps and/or navigation directions are provided via special-purpose software applications such as mapping applications or “apps” as well as via general-purpose software applications such as web browsers.

Software applications typically provide navigation directions for a particular mode of transport such as driving, walking, or taking a bus, etc. The user typically specifies the mode of transport along with the starting point and the destination or, in some cases, a software application generates navigation directions for the mode of transport the user select last. These navigation directions are not always optimal. For example, for a certain starting location and a certain destination, a typical software application provides one option that includes subway and bus and is expected to last 45 minutes, a 30-minute cab ride as another option, and a 30-minute bicycle as the third option. However, the user has established experimentally that the fastest option in fact is taking a short cab rite and then an express bus, with the whole trip taking only 15 minutes. As another example, the typical software application for another pair of locations provides ride share that takes 2 hours and 15 minutes, at the total cost of approximately $200, as one option; and public transport that takes approximately 15 hours at the cost of $10 as another option. However, it is possible for the user to also take a cab to a certain train station and travel the rest of the way by train, bringing the total travel to approximately two hours and the total cost to $20.

### SUMMARY

Generally speaking, a software system of this disclosure determines a multi-modal route for travelling from a certain source to a certain destination, with a segment of the multi-modal route corresponding to a type of public transport (e.g., train, bus, ferry) and another segment corresponding to a type of private transport (e.g., ride share). The software system can determine the multi-modal route in view of such factors as time and cost. In some implementations, the software system allows the user to specify how much importance should be attributed to each factor (e.g., “cost is twice as important as time.”). When generating a multi-modal route, the software system can account for certain factors that make certain modes of transport more cost effective and/or more likely to be available, such as the projected spikes in ridership at certain locations and/or certain times that make ride share options more likely to be used.

One example embodiment of these techniques is a method for generating multi-modal navigation directions for a user. The method can be executed by one or more processors. The method includes receiving an indication of a first starting location and a first destination from a first user, receiving an indication of a second starting location and a second destination from a second user, and generating a multi-modal route from the first starting location to the first destination for the first user in view of the second user travelling from the second starting location to the second destination. Generating the multi-modal route includes generating (i) a ride share segment of the multi-modal route which the first user and the second user can traverse together using a ride share service and (ii) a segment of the route associated with a mode of transport other than the ride share service. The method further includes providing an indication of the multi-modal route from the first starting location to the first destination.

Another example embodiment of these techniques is a computing system comprising one or more processors and a non-transitory computer-readable memory storing instructions for generating multi-modal navigation directions for users. When executed by the one or more processors, the instructions cause the computing system to receive an indication of a first starting location and a first destination from a first user device operated by a first user, receive an indication of a second starting location and a second destination from a second user device operated by a second user, generate a multi-modal route from the first starting location to the first destination for the first user in view of the second user travelling from the second starting location to the second destination, including generate (i) a ride share segment of the multi-modal route which the first user and the second user can traverse together using a ride share service and (ii) a segment of the route associated with a mode of transport other than the ride share service, and provide, to the first user device, an indication of the multi-modal route from the first starting location to the first destination.

Yet another example embodiment of these techniques is a computing device comprising one or more processors, a user interface configured to receive input from a user and provide output to the user, a network interface to communicate with one or more servers via a communication network, and a non-transitory computer-readable memory storing instructions for obtaining multi-modal navigation directions. The instructions, when executed by the one or more processors, cause the computing device to receive an indication of a starting location and a destination via the user interface, receive a selection of a private transport option and a public transport option via the user interface, receive an indication of a multi-modal route from the first starting location to the first destination from the one or more servers, and provide an indication of the multi-modal route from the first starting location to the first destination, via the user interface. The multi-modal route includes (i) a public transport segment associated with a public mode of transport, and (ii) a ride share segment which the first user can traverse together with another user using a ride share service.

Still another embodiment of these techniques is a method in a computing device for generating navigation directions in view of multiple factors. The method includes receiving, by one or more processors, an indication of a starting location and a destination from a first user device operated by a first user. The method further includes receiving, by the one or more processors via a user interface, a selection of a first weight to be applied to a cost (or price) factor and a second weight to be applied to a time factor, wherein each of the first weight and the second weight has a respective value greater than zero and less than one hundred percent. The method further includes generating a route from the first starting location to the first destination in view of the first weight and the second weight, and providing an indication of the route from the first starting location to the first destination via the user interface.

In various embodiments, the method above for generating navigation directions in view of multiple factors includes one or more of the following features. The method includes providing, via the user interface, a first interactive control for selecting the first weight, and a second interactive control for selecting the second weight. The first and second interactive controls include respective slide bars. Generating the route includes generating a multi-modal route with (i) a ride share segment which the user can traverse together using a ride share service and (ii) a public transport segment associated with a public mode of transport. Generating the route includes generating multiple candidate routes and, for each of the multiple candidate routes: determining a respective cost of each route, determining a respective time for each route, and applying the first weight and the second weight to the cost and the time, respectively, to calculate an overall score of the route; and selecting the route from among the multiple candidate routes based on the corresponding overall scores.

### BRIEF DESCRIPTION OF THE DRAWINGS

FIG. 1 is a block diagram of an example system in which techniques for providing multi-modal routing can be implemented;

FIG. 2 is a flow diagram of an example method for generating navigation directions in view of user-specified factors, which can be implemented in the client computing device of FIG. 1;

FIG. 3 is an example user interface screen that a mapping application operating in the client computing device of FIG. 1 can generate to receive factors used in generating navigation directions;

FIG. 4 is a flow diagram of an example method for generating a multi-modal route for a user in view of another user;

FIG. 5 schematically illustrates a scenario where multi-modal routes of two users share a segment associated with public transport; and

FIG. 6 is a messaging diagram of an scenario in which a server operating in the system of FIG. 1 generates multi-modal routes for two devices operated by different respective users.

### DETAILED DESCRIPTION

### Overview

As referred to herein, a multi-modal route between a certain starting location (or “source”) and a certain destination includes at least two segments which a user can traverse using different modes of transport. Some of the modes of transport are public. Examples of public transport include subway, bus, train, tram or trolley, ferry, etc. Other modes of transport, such as car or bicycle, are private. Certain ride share provides today can operate similar to traditional taxis and service individuals or small requesting the ride together, as well as providers of carpooling services, i.e., rides shared between strangers to reduce cost. In either case, transport provided by ride share services is referred to herein as a private mode of transport.

The software system of this disclosure generates a multi-modal route that includes at least one segment which the user traverses using a public mode of transport and at least one segment which the user traverses using a private mode of transport. This multi-modal route may be more time-efficient and/or cost-efficient relative to a single-mode route from the starting to the destination or a multi-mode route that uses only public transport options (e.g., subway followed by bus). For example, for a certain starting location, the software system may generate a multi-modal route that involves a relatively short ride using private transport to a transportation hub which is difficult to access using public transport from the starting location, and a subsequent ride using public transport. The software system thus may identify an intermediate location at which the user can switch from private transport to public transport or, conversely, from public transport to private transport.

As discussed in more detail below, the software system can generate a multi-modal route with segments corresponding to private as well as public modes of transport by iteratively considering candidate locations, determining the timing and the cost of segments terminating at these candidate locations, determining the timing of switching between the modes of transport, and determining the overall time and cost. To this end, the system can invoke an API provided by a third-party provider of a ride share services to obtain the time and cost estimate for a segment of a route, or estimate the time and cost of a ride using historical data, for example.

The software system in some cases determines when the cost of traversing a route can be reduced by identifying locations where the carpooling option can be used. In one example scenario, the software system identifies a spike in ridership for a certain type of public transport, at a certain time, and generates a suggestion for carpooling from a transportation hub where a number of passengers are expected to arrive. In another example scenario, the software system determines that multiple users who requested navigation directions have a shared segment which they case quickly and cost-efficiently traverse using a ride share service.

Further, the software system in some implementations allows the user to specify the relative importance of time and cost factors. Rather than requesting that the system optimize the route for time or cost, the user can indicate, for example, that time is twice as important as cost. The software system to this end can provide interactive controls such as slide bars for assigning numerical values to these factors.

The software system can include components executing on a client device, such as mapping and/or navigation applications; components executing on a server, such as a routing engine configured to generate routes to service requests from client devices; and, in some cases, components provided by third parties, such as an API exposed by a third-party provider of ride share services and invoked by a client device or a server.

### Example Computing Environment

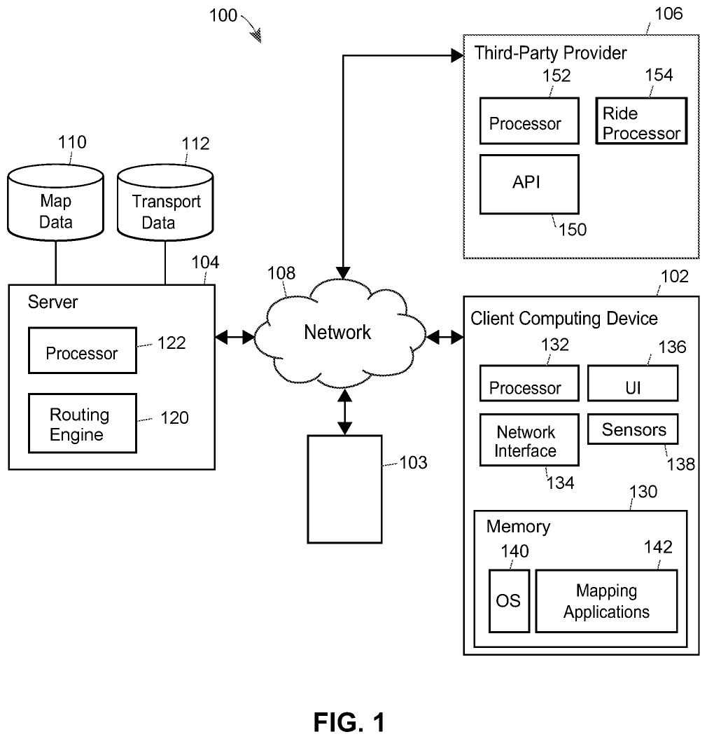

Referring to FIG. 1, an example communication system 100 in which the techniques outlined above can be implemented includes client computing devices 102, 103, etc. which can be for example personal computers, portable devices such as tablet computers or smartphones, wearable computing devices, special-purpose car navigators, devices embedded in head units of vehicles, etc. The communication system 100 in general can include any suitable number of client computing devices.

The communication system 100 further includes one or more server devices 104 (only one shown for simplicity) operated by a provider of mapping and navigation services. The server device 104 can provide map data and navigation data to the client computing device 102 and other client devices. Still further, the communication system 100 in this example configuration includes one or more servers 106 (only one shown for simplicity) of a third-party provider of ride share services. The third-party provider operates independently and separately of the provider with which the server device 104 is associated. The communication system 100 in general can include any suitable number of providers of content and/or databases related to transportation, such as providers of scheduling and routing information for trains, buses, ferries, etc. The server devices 104, 106, the client computing devices 102, 103, and any other data providers can communicate with each other via a network 108. The network 108 can be a wide area network such as the Internet, for example, and include wired and/or wireless communication links.

The server device 104 can be communicatively coupled to a database 110 that stores map data for various geographic areas. The map data can be stored in any suitable format such as vector graphics, rasterized images, text for labels, etc. and organized according to any suitable principle (e.g., square map tiles covering the same amount of area at a certain zoom level). The map data can specify the shapes and various properties of geographic features such as roads, buildings, lakes, rivers, parks, etc. The map data also can include street-level imagery and photographs taken from various vantage points. Further, map data for a geographic areas can include information about brick-at-mortar businesses located at the respective locations within the geographic area: hours of operation, description of products and services, user reviews, etc.

The server device 104 in this example configuration is communicatively coupled to a transport database 112 that stores data related to public and private types of transport. For example, the transport database 112 can store routes and scheduled for trains, buses, and other types of public transport. The transport database 112 also can store historical data that indicates when, where, for what destinations, etc. users tend to request a ride share services. The transport database 112 in some cases also stores pricing information for various public and/or private types of transport.

Other database which the server device 104 can access during operation can store traffic data, weather data, commercial data (advertisements, offers, coupons, etc.), event data (e.g., music, movies, concerts) and any other data related or relatable to geography.

Using the map data stored in the databases 110 and 112, a routing engine 120 can generate maps of geographic areas as well as routes traversing these geographic areas, including multi-modal routes that include both public-transport segments and private-transport segments. The routing engine 120 can be implemented as a set of instructions stored in a memory that includes non-transitory medium such as a hard disk, a flash drive, etc., and executable by one or more processors 122.

With continued reference to FIG. 1, the client computing device 102 can include a memory 130, one or more processors 132, a network interface 134, a user interface (UI) 136, and sensors 138. The memory 130 can be a non-transitory memory and can include one or several suitable memory modules, such as random access memory (RAM), read-only memory (ROM), flash memory, other types of persistent memory, etc. The network interface 134 can support any suitable communication protocol to communicate with remote servers and other devices via the communication network 108. The UI 136 can include any suitable combination of input devices such as a touchscreen, a keyboard, a microphone, etc. and output devices such as screens, speakers, etc. Depending on the implementation, the one or more sensors 138 can include a global positioning system (GPS) module to detect the position of the client computing device 102, a compass to determine the direction of the client computing device 102, a gyroscope to determine the rotation and tilt, an accelerometer, etc.

The memory 130 stores an operating system (OS) 140, which can be any type of suitable mobile or general-purpose operating system. The memory 130 also stores a mapping and navigation application 142, which can be configured to generate interactive digital maps and navigation instructions. The mapping application 142 can receive map data in a raster (e.g., bitmap) or non-raster (e.g., vector graphics) format from the map data database 110 and/or the server device 104. In some cases, the map data can be organized into layers, such as a basic layer depicting roads, streets, natural formations, etc., a traffic layer depicting current traffic conditions, a weather layer depicting current weather conditions, a navigation layer depicting a path to reach a destination, etc. The mapping application 142 can provide navigation directions as a graphic overlay on a digital map, as a sequence of instructions that include text and/or images, as a set of vocalization instructions via speakers, or any suitable combination thereof. The mapping application 142 can provide digital maps and navigation instructions natively via the UI 136 or in a projected mode via the head unit of a vehicle, for example.

The memory 130 also can store instructions that implement an third-party ride share API, which the client computing device 102 can receive from the third-party provider 106. In this example, the third-party provider 106 provides an API 150 to client devices as well as the server 104. The API 150 can expose such functionality as requesting availability of ride share options for a specified location and a specified time, obtaining pricing options, obtaining travel time estimate, requesting a ride share service for a specified location and a specified time, obtaining information regarding the progress of a ride, etc. In an example implementation, the third-party provider 106 can provide ride services similar to traditional taxi or limousine service where an individual or a small group of people travelling together request a private car, as well as carpooling services where people who may be unfamiliar with each other share a ride or a portion of the ride and split the fare accordingly. Depending on the implementation, the server 104 and/or the client computing devices 102, 103 can invoke the API 150 to obtain information about a potential or actual ride. In addition to the API 150, the memory of the third-party provider 106 can store instructions that include ride processing software 154 which processes requests from clients 102, 103 and/or the server 104 for rides of various types.

For simplicity, FIG. 1 illustrates the server device 104 as only one instance of a server. However, the server device 104 according to some implementations includes a group of one or more server devices, each equipped with one or more processors and capable of operating independently of the other server devices. Server devices operating in such a group can process requests from the client computing device 102 individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices.

### Selecting a Route in View of Multiple Parameters Specified by a User

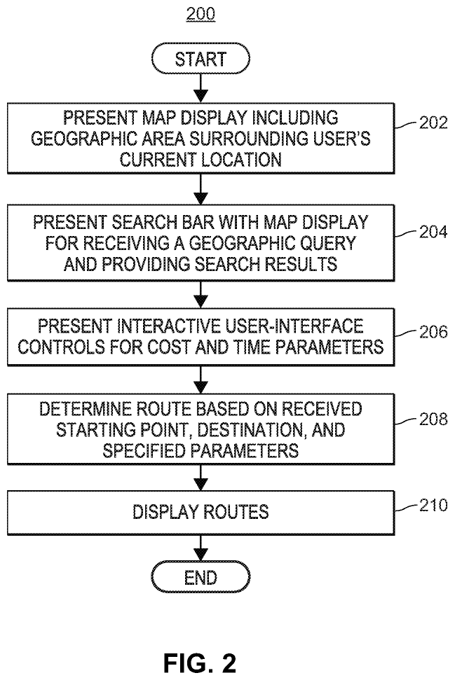

FIG. 2 illustrates is a flow diagram of an example method 200 for generating navigation directions for routes in view of multiple user-specified factors. The generated routes in some cases are multi-modal routes with segments associated with public transport as well as segments associated with private transport. The method 200 may be implemented in a set of instructions stored on a computer-readable memory and executable by one or more processors of the client computing device 102 and/or the server device 104. For convenience, the method 200 is discussed below with reference to the mapping application 142.

At block 202, the mapping application 142 can provide an interactive digital map of a geographic area of the current location of the user. More generally, the mapping application 142 can provide any suitable entry point for requesting navigation directions. For example, the mapping application can display an informational card for a certain point of interest and provide a control for directly requesting navigation directions. As another example, the mapping application 142 can detect a voice command requesting navigation directions.

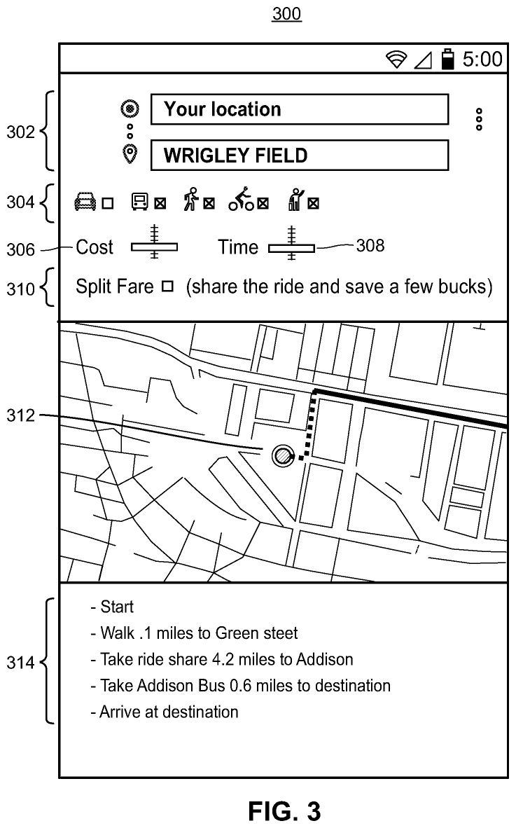

In the example method 200, the mapping application 124 presents a search bar or another suitable control for receiving an indication of a geographic location in the form of an address (e.g., “120 Adams St.”), the name of a point of interest (e.g., “Yankee Stadium”), or a type of a point of interest (e.g., “coffee shop”), or any other suitable form. Once the mapping application 124 provides the one or more search results in the form of an interactive on the map, a list, or an informational card, the user can activate the appropriate control or provide the appropriate vocal command to request navigation directions to the geographic location. For example, as illustrated in FIG. 3, the mapping application 124 can provide entry boxes 302 for specifying the starting point and the destination as part of an interface 300. The interface 300 in some implementation also can provide controls for selecting the time at which the user wishes to leave, the time when the user wishes to arrive at the destination, etc.

At block 206, the mapping application 142 can provide interactive controls for assigning weights to cost, time, and other parameters to be used when generating a route between the starting location and the destination. Referring to FIG. 3, for example, the mapping application 142 can provide slide bars 306 and 308 via which the user can specify the importance of cost and time, respectively. The range of importance can be zero to 100%, in an example implementation. The slide bars 306 and 308 in some implementations are interconnected so that, for example, specifying that the importance of cost is 75% via the slide 306 causes the mapping application to automatically set the importance of time to 25%. Of course, the user can operate the slide bars 306 and/or 308 to specify that the importance of one cost is 100%, and the importance of time is 0%, or vice versa.

The mapping application 142 also can provide controls for selecting acceptable modes of transport, without restricting the user to public or private modes of transport. As illustrated in FIG. 3, the user can check off as many boxes as desired in an area 304. When the user checks both options corresponding to private transport and public transport, the system of FIG. 1 assesses potential routes that include private modes of transport only, public modes of transport only, and both public and privates mode of transport. Further, the interface 300 can include a toggle option 310 to allow the user to select to the carpool option. In some implementation, the mapping application 142 displays the toggle option 310 only when the user selects the ride share option via one of the controls 304.

At block 208, a navigation route is determined in accordance with the selections specified via the controls 306, 308, and 310. Several example scenarios are considered next for further clarity.

In one scenario, the user specifies a starting point and a destination, selects public transport only, and indicates that cost is twice is important as time. The mapping application 142 in this example scenario obtains a single-mode route. In contrast to a system that optimizes a route for either time or cost, here the mapping application 142 and/or the server 104 may generate a route that costs more than the route optimized for cost but less than the route optimized for time, and takes more time than the route optimized for time but less time than the route optimized for cost. To this end, the system can determine a candidate route, calculate the expected cost and time for the route, apply respective weights to the cost and time estimates, and calculate the sum of the weighted cost and time estimates to determine an overall score for the route. The system then can select the route with the highest or lowest overall score, depending on how the scores were calculated.

In another scenario, the selects both public and private transport options and indicates that both cost and time are important via the controls 306 and 308. The system can iteratively consider multiple intermediate locations where the user can transition between public and private modes of transport. For example, the system can determine that the destination is within a walking distance of a subway station, but the starting location is outside the walking distance of a subway station. The system can obtain time and cost estimates for ride share service between the starting location and the subway station more proximate to the starting location, obtain time and cost estimates for the subway ride, and determine the overall score for the route. The system thus can generate a multi-modal route that includes both private and public modes of transport.

The system similarly can identify multiple stations, stops, and other public transport “endpoints” proximate to the starting location and the destination. For each of these public transport endpoints, the system can consider the cost and time of reaching the endpoint by a private transport or, conversely, transitioning to private transport at the public transport endpoint. In general, a route can involve any number of transitions between private and public transport: the system in one instance generates a route that begins with a short ride in a private car, includes a relatively long train ride, and ends with another relatively short ride in a private car; in another instance, in another instance the system generates a route that consists of a walk to a bus stop, a ride on a bus, and a carpool ride in a private car.

To determine the expected cost and/or time of a ride by a third-party provider, the system can invoke an appropriate API exposed by a third-party provider, such as the API 150 of FIG. 1 or generate an estimate using historical data that indicates average times and cost for various pairs of endpoints, for example.

With continued reference to FIG. 2, one or more routes generated as discussed above can be provided for the user for selection at block 210. The mapping application 142 can display multiple routes as separate overlays on the same digital map, visually distinguished from each other using color or shading, for example. Once the user then selects one of these routes, the system can generate navigation directions for guiding the user along the selected route. The system can provide the navigation directions in the form of graphics overlaying a digital map, text, voice instructions, etc. The example user interface 300 of FIG. 3 includes a map portion 312 to illustrate the first segments of the route (or the entire route, for example, depending on the user selection) and a high-level textual overview of the route in a box 314.

When the user chooses a route that includes a ride share segment that is not first in the sequence of segments of a multi-modal route, the system can estimate the time when the user reaches the pick-up location and provide an option to request pick-up at some future time. For example, when the multi-modal route is made up of a walking segment followed by a bus ride and further followed by a ride share segment, the system can estimate the time when the user reaches the pick-up location for the ride share segment, so that the ride share can be requested for the pick-up location at in advance.

### Selecting a Multi-Modal Route With a Carpooling Segment

In some cases, the system can determine that respective multi-modal routes can be generated for several users that travel to respective destinations, with a segment which the several users can traverse together by sharing a private transport provided by a ride share service, i.e., by carpooling. The carpooling segment typically lowers the overall cost of the trip for both users relative to private transport used exclusively by each user. Further, the carpooling segment can lower the overall time for the route relative to a public transport option.

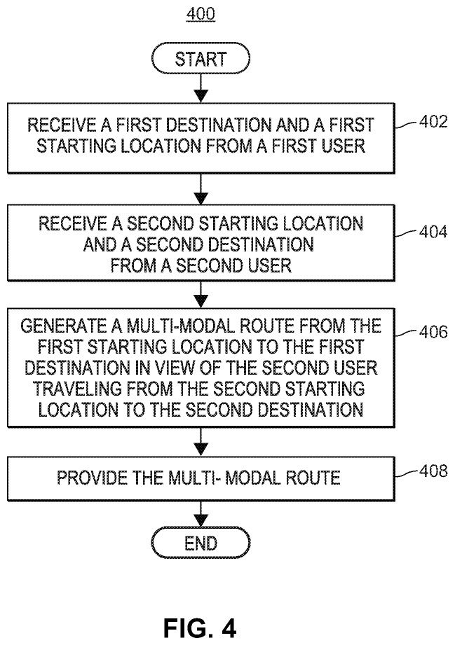

More particularly, FIG. 4 is a flow diagram of an example method 400 for generating a multi-modal route for a user in view of another user. Similar to the method 200, the method 400 may be implemented in a set of instructions stored on a computer-readable memory and executable by one or more processors of the client computing device 102 and/or the server device 104. For convenience, the method 400 is discussed below with reference to the mapping application 142

The method 400 begins at block 402, where a request for a route and associated navigation directions is received from the first user operating a first client computing device (e.g., the device 102). The request can include a certain starting location, which in some cases the mapping application 142 infers based on the current location of the client computing device, and the destination.

At block 404, a request for a route and associated navigation directions is received from the second user operating a second client computing device (e.g., the device 103). The request also can include a certain starting location and the destination.

In some cases, the system generates a multi-modal route for the first user in view of the second user, at block 406. In particular, the system can determine that a certain candidate route includes a segment which the first user can traverse using a ride share service without the carpooling option, at a certain cost and with a certain expected time expenditure. The system then can determine that a candidate route for another user can include the same segment. If both users indicated their willingness to consider the carpooling option (e.g., by operating the control 310 in FIG. 3), the system can determine that the cost of the routes for both users can be lowered if the two users share a private transport provided by a ride share service and traverse the segment together.

As a more specific example, a concert, a sports game, a rally, or another event may be scheduled to begin at a certain venue at a certain time, and a large number of people can be expected to reach a train station two miles away from the venue within the same window of time. The system can define the window to span 10 minutes, 15 minutes, 20 minutes, etc. The first user and the second user can reach the train station from different places at approximately the same time, and thus the system of this disclosure can generate multi-modal routes that include ride share segments with carpooling.

Further, after the event is over, many of the attendees may be expected to use the ride share option to get back to the train station at approximately the same time, and the system again can generate multi-modal routes for users in view of the other users' travel plans. Thus, in various scenarios, a segment associated with carpooling can precede a segment associated with public transport or, conversely, a segment associated with public transport can precede a segment associated with carpooling.

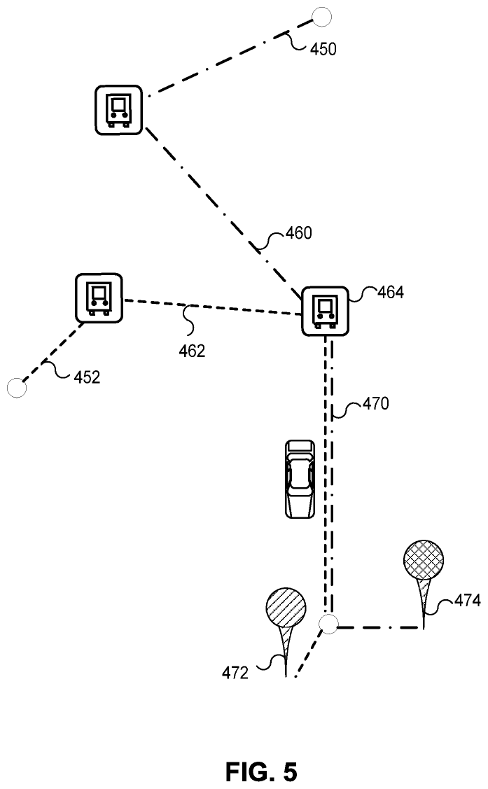

FIG. 5 schematically illustrates an example scenario where the multi-modal route for the first user includes subway segments 450 and 460, a ride share segment 470, and a short walk to the destination 474 (segments are not drawn to scale in FIG. 5). A multi-modal route for the second user includes different subway segments 452 and 462, the ride share segment 470, and a short walk to the destination 472. The ride share segment 470 beings at a train station 464.

If the first and second users do not arrive at the station 464 at the same time, the system can calculate the scores for the corresponding multi-modal route in view of the wait time. For example, if the first user would arrive at the station at 464 at 10:00 am, and the second user would arrive at the station 464 at 10:05 am, carpooling with the second user adds five minutes to the first user's route. However, the carpooling with the second user also may be projected to reduce the overall cost of the first user's route by three dollars, for example. The system can calculate the overall score for the first route in view of the weights assigned to cost and time via the user interface 300, for example (see FIG. 3).

Although the first and second users share both the segment 470 and the pick-up location 464 in the scenario of FIG. 5, in general the system need not require that the pick-up location be the same. For example, a private transport can pick one user at one location, pick up the second user at another location, and the shared segment accordingly can begin at the pick-up location of the second user.

Referring again to FIG. 4, an indication of the multi-modal route can be provided to the first user at block 408. When the user chooses the suggested multi-modal route, the system may coordinate the ride share segment by communicating with the second user and the ride share provider.

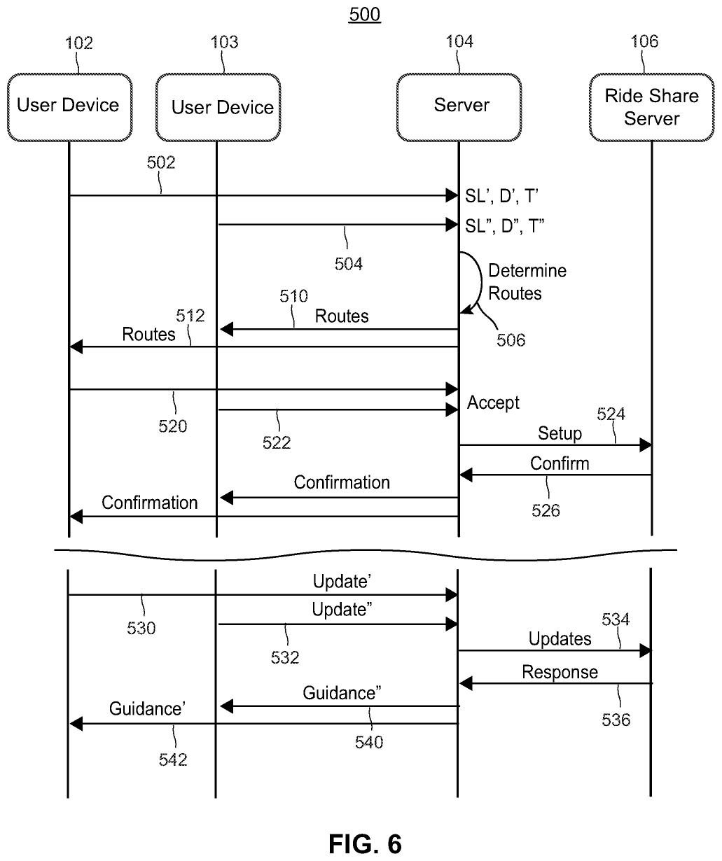

Next, FIG. 6 depicts a messaging diagram of a scenario 500 in which a server operating in the system of FIG. 1 generates multi-modal routes for the devices 102 and 103 operated by different users. The user specifies a starting location, a destination, a time of travel, and the user device 102 provides these parameters to the server 104 via a message 502. The user similarly specifies a starting location, a destination, a time of travel, and the user device 103 provides these parameters to the server 104 via a message 504. The server 104 determines multi-modal routes (event 506) and provides the corresponding indications 510 and 512. The multi-modal routes in this scenario share a segment which the users operating the devices 102 and 103 can traverse together using a shared ride.

Once the users select the multi-routes with the shared segment, the devices 102 and 103 forward the corresponding indications 520 and 522 to the server 104. The server 104 in this scenario can automatically set up the shared ride for the users operating the device 102 and 103 by communicating with the ride share server (event 524) and receiving a confirmation (event 526).

In some scenarios, the server 104 continues to receive updates regarding the progress of the user devices 102 and 103 along the respective routes (events 530, 532). The server 104 in turn can update the ride share server 106 (events 534, 536). The ride share server 160 can provide updates guidance to the user devices 102 and 103 (events 540, 542). For example, in some cases, the ride share server can automatically adjust the pick-up time if one or both of the users experience a delay of duration that is below a certain predefined threshold (e.g., 1 min, 2 minutes). In other cases, the ride share server 106 can notify a user that the carpooling option is no longer available (e.g., if one of the users cannot arrive at the pick-up location within the predefined threshold of the previously determined pick-up time).

### Identifying a Probable Ride Share Opportunity for a Multi-Modal Segment

In another example scenario, the system receives a request for navigation directions from a user and identifies an efficient candidate multi-modal route with a ride share segment. The user has indicated that carpooling is an option, but the system cannot identify another user who could share the ride share segment with the user in a car pooling arrangement, at the time of the request for navigation directions. However, the system can determine that a ride share provider is likely to offer carpooling to the user when the user reaches the pick-up location. The system for example can determine for example that the number of riders using private transport typically increases at the time when the user will require the ride share service, at the pick-up location or in the general vicinity of the pick-up location.

As a more specific example, the system can generate a multi-modal route according to which the user gets off a train at a transportation hub and uses a ride share service to travel the rest of the way. The system can use historical aggregate data to determine that a relatively large number of people request a ride share at the transportation hub, approximately at the time when the user gets off the train. The system accordingly determine that the ride share service likely will offer a carpooling option to the user (and accordingly lower the overall cost of the trip), and assign a corresponding score to the multi-modal route.

More generally, the system can use any number of suitable signals to determine the likelihood that a ride share service, or a particular type of a ride share service, will be available at a certain location at a certain time. Such signals can include historical data for various locations and times, public transportation schedules when historical data is not available, information regarding various events (e.g., concerts, sports events), information regarding temporary unavailability of certain public modes of transport (e.g., train service becoming unavailable due to a breakdown or accident), etc.

Further, the system similarly can use various signals to determine the probable availability of a ride share service when the ride segment is not the first segment in a route, and when a ride share provider cannot provide an estimate or a booking in advance. For example, the system can identify a candidate multi-modal route that involves a relatively long train ride (e.g., five hours) followed by a ride using a private transport. The system can use signals similar to those discussed above to determine whether ride share likely will be available, the wait time, etc. The system in this case can determine the probable availability of a ride share service regardless of whether the user is willing to carpool.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configured on a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 200 and 400 may include one or more function blocks, modules, individual functions or routines in the form of tangible computer-executable instructions that are stored in a non-transitory computer-readable storage medium and executed using a processor of a computing device (e.g., a server, a personal computer, a smart phone, a tablet computer, a smart watch, a mobile computing device, or other personal computing device, as described herein). The methods 200 and 400 may be included as part of any backend server (e.g., a map data server, a navigation server, or any other type of server computing device, as described herein), portable device modules of the example environment, for example, or as part of a module that is external to such an environment. Though the figures may be described with reference to the other figures for ease of explanation, the methods 200 and 400 can be utilized with other objects and user interfaces. Furthermore, although the explanation above describes steps of the methods 200 and 400 being performed by specific devices (such as a client computing devices 102, 103, and a server device 104), this is done for illustration purposes only.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for generating navigation routes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for generating multi-modal navigation directions for users, the method comprising:
receiving, by one or more processors, an indication of a first starting location and a first destination from a first user device operated by a first user;
receiving, by the one or more processors, an indication of a second starting location and a second destination from a second user device operated by a second user;
generating a multi-modal route from the first starting location to the first destination for the first user in view of the second user travelling from the second starting location to the second destination, including generating (i) a ride share segment of the multi-modal route which the first user and the second user can traverse together using a ride share service and (ii) a segment of the route associated with a mode of transport other than the ride share service; and
providing, to the first user device, an indication of the multi-modal route from the first starting location to the first destination.

2. The method of claim 1, wherein generating the ride share segment includes:
determining a public transport segment immediately preceding the ride share segment, which the first user can traverse using a public transport, wherein the public transport segment terminates, and the ride share segment begins, at a pick-up location; and
determining that the first user and the second user are likely to arrive at the pick-up location within a threshold amount of time of each other.

3. The method of claim 2, wherein determining that the first user and the second user are likely to arrive at the pick-up location at a same time includes:
determining that the first user and the second user will use a same mode of public transport to arrive at the pick-up location.

4. The method of claim 2, wherein determining that the first user and the second user are likely to arrive at the pick-up location within a threshold amount of time of each other includes obtaining scheduling information for the public transport segment.

5. The method of claim 2, wherein determining that the first user and the second user are likely to arrive at the pick-up location within a threshold amount of time of each other includes analyzing statistical data for a plurality of prior rides.

6. The method of claim 1, wherein determining that the first user and the second user are likely to arrive at the pick-up location at a same time includes:
determining a public transport segment immediately following the ride share segment, wherein the public transport segment begins, and the ride share segment ends, at a drop-off location; and
determining that the first user and the second user are likely to arrive at the drop-off location within a threshold amount of time of each other.

7. The method of claim 1, wherein the multi-modal route is a first multi-modal route, the method further comprising:
generating a second multi-modal route from the second starting location to the second destination for the second user in view of the first user; and
providing, to the second user device, an indication of the second multi-modal route to the second user.

8. The method of claim 7, further comprising:
in response to receiving an indication that the first user and the second user requested navigation directions:
providing navigation directions corresponding to the first multi-modal route and the second multi-modal route, respectively, and
automatically requesting a ride for the ride share segment, including invoking an API provided by a third party.

9. The method of claim 1, further comprising:
receiving, from the first user device, a selection of a first weight to be applied to a price factor and a second weight to be applied to a time factor; and
generating the multi-modal route in view of the first weight and the second weight.

10. A computing system comprising:
one or more processors; and
a non-transitory computer-readable memory storing thereon instructions for generating multi-modal navigation directions for users, wherein the instructions, when executed by the one or more processors, cause the computing system to:
receive an indication of a first starting location and a first destination from a first user device operated by a first user,
receive an indication of a second starting location and a second destination from a second user device operated by a second user,
generate a multi-modal route from the first starting location to the first destination for the first user in view of the second user travelling from the second starting location to the second destination, including generate (i) a ride share segment of the multi-modal route which the first user and the second user can traverse together using a ride share service and (ii) a segment of the route associated with a mode of transport other than the ride share service, and
provide, to the first user device, an indication of the multi-modal route from the first starting location to the first destination.

11. The computing system of claim 10, wherein to generate the ride share segment, the instructions cause the computing system to:
determine a public transport segment immediately preceding the ride share segment, which the first user can traverse using a public transport, wherein the public transport segment terminates, and the ride share segment begins, at a pick-up location; and
determine that the first user and the second user are likely to arrive at the pick-up location within a threshold amount of time of each other.

12. The computing system of claim 11, wherein to determine that the first user and the second user are likely to arrive at the pick-up location within a threshold amount of time of each other, the instructions cause the computing system to determine that the first user and the second user will use a same mode of public transport to arrive at the pick-up location.

13. The computing system of claim 11, wherein to determine that the first user and the second user are likely to arrive at the pick-up location within a threshold amount of time of each other, the instructions cause the computing system to obtain scheduling information for the public transport segment.

14. The computing system of claim 11, wherein to determine that the first user and the second user are likely to arrive at the pick-up location within a threshold amount of time of each other, the instructions cause the computing system to analyze statistical data for a plurality of prior rides.

15. The computing system of claim 10, wherein to generate the ride share segment, the instructions cause the computing system to:
determine a public transport segment immediately following the ride share segment, wherein the public transport segment begins, and the ride share segment ends, at a drop-off location; and
determine that the first user and the second user are likely to arrive at the drop-off location within a threshold amount of time of each other.

16. The computing system of claim 10, wherein the multi-modal route is a first multi-modal route, and wherein the instructions further cause the computing system to:
generate a second multi-modal route from the second starting location to the second destination for the second user in view of the first user; and
provide, to the second user device, an indication of the second multi-modal route to the second user.

17. The computing system of claim 16, wherein the instructions cause the computing system to, in response to receiving an indication that the first user and the second user requested navigation directions:
provide navigation directions corresponding to the first multi-modal route and the second multi-modal route, respectively, and
automatically request a ride for the ride share segment, including invoke an API provided by a third party.

18. The computing system of claim 10, wherein the instructions further cause the computing system to:
receive, from the first user device, a selection of a first weight to be applied to a price factor and a second weight to be applied to a time factor; and
generate the multi-modal route in view of the first weight and the second weight.

19. A computing device comprising:
one or more processors;
a user interface configured to receive input from a user and provide output to the user;
a network interface to communicate with one or more servers via a communication network; and
a non-transitory computer-readable memory storing thereon instructions for obtaining multi-modal navigation directions, wherein the instructions, when executed by the one or more processors, cause the computing device to:
receive an indication of a starting location and a destination via the user interface,
receive a selection of a private transport option and a public transport option via the user interface,
transmit the indication and the selection to the one or more servers; and
receive an indication of a multi-modal route from the first starting location to the first destination from the one or more servers, the multi-modal route including (i) a public transport segment associated with a public mode of transport, and (ii) a ride share segment which the first user can traverse together with another user using a ride share service, and
provide an indication of the multi-modal route from the first starting location to the first destination, via the user interface.

20. The computing device of claim 19, wherein the instructions cause computing device to:
receive a selection of a first weight to be applied to a price factor and a second weight to be applied to a time factor, and
provide the selection of the first weight and the second weight to the one or more servers, wherein the multi-modal route is generated in view of the selection.
